(19) United States
(12) Patent Application Publication
(10) Pub. No.: US 2013/0262692 A1
(43) Pub. Date: Oct. 3, 2013

(54) System and Methods of Media Streaming from a Media Server using RTSP with Reduced Delays

(71) Applicants: Yuri Bulava, Tomsk City (RU); Sergey Rachev, Tomsk City (RU); Denis Khromov, Moscow (RU)

(72) Inventors: Yuri Bulava, Tomsk City (RU); Sergey Rachev, Tomsk City (RU); Denis Khromov, Moscow (RU)

(73) Assignee: Rovi Corp, Santa Clara, CA (US)

(21) Appl. No.: 13/432,539

(22) Filed: Mar. 28, 2012

(51) Int. Cl. G06F 15/16

(52) U.S. Cl. 709/231

(57) ABSTRACT

Systems and method of media streaming using the Real Time Streaming Protocol (RTSP) with reduced delays in accordance with embodiments of the invention are disclosed. In one embodiment of the invention, a media server includes media storage containing stored media, wherein the media server is configured to stream media stored in the media storage, determine the end of the streamed media, where the end of the streamed media signals that the streamed media has been fully streamed, create an end of file message, where the end of file message causes the recipient of the end of file message to complete decoding of any buffered media irrespective of any other buffering criteria, and send the end of file message.

### FIELD OF THE INVENTION

The present invention is directed, in general, to systems and methods for streaming data over a network and more specifically to systems and methods for streaming data utilizing the Real Time Streaming Protocol.

### BACKGROUND

Streaming video over the Internet has become a phenomenon in modern times. Many popular websites, such as YouTube, a service of Google, Inc. of Mountain View, Calif., and WatchESPN, a service of ESPN of Bristol, Conn., utilize streaming video in order to provide video and television programming to consumers via the Internet.

The Transmission Control Protocol (TCP) is a protocol for transmitting a stream of bytes over IP networks. TCP provides reliable, ordered delivery between endpoints on a network. TCP is designed to ensure accurate delivery, requiring that the receiving computer acknowledge each packet of data before delivering the data to the receiving computer. This acknowledgement process, while ensuring reliable, ordered delivery, can cause delays of up to several seconds if transmission errors occur.

The Real-time Transport Protocol (RTP) is a standardized packet format for delivering multimedia data over Internet Protocol (IP) networks. RTP commonly utilizes the User Datagram Protocol (UDP) as the transport layer; however, TCP may also be utilized for the transport layer. RTP is used in situations where stream data, such as audio or video data, is to be transported end-to-end in real-time. RTP is optimized for speed of transmission rather than reliability; however RTP provides the ability to correct for common errors in data transferred over IP networks, such as jitter and data that has arrived out of sequence.

The Real Time Streaming Protocol (RTSP) is designed to stream data over a network utilizing a variety of protocols, including RTP. RTSP is used by a variety of commercially available media streaming systems, including the QuickTime Streaming Server, a product of Apple, Inc. of Cupertino, Calif., and the Helix Universal Server, a product of RealNetworks of Seattle, Wash. RTSP is used to establish and control media sessions between endpoints, such as between a media server and a client machine. The client machines can issue commands, such as play, pause, and stop, to enable the real-time control of playback of media files stored on the server.

### SUMMARY OF THE INVENTION

Systems and method of media streaming using the Real Time Streaming Protocol (RTSP) with reduced delays in accordance with embodiments of the invention are disclosed. In one embodiment of the invention, a media server includes media storage containing stored media, wherein the media server is configured to stream media stored in the media storage, determine the end of the streamed media, where the end of the streamed media signals that the streamed media has been fully streamed, create an end of file message, where the end of file message causes the recipient of the end of file message to complete decoding of any buffered media irrespective of any other buffering criteria, and send the end of file message.

In another embodiment of the invention, the media is streamed using the Real Time Streaming Protocol (RTSP).

In an additional embodiment of the invention, the end of file message is a RTSP SET_PARAMETER request.

In yet another additional embodiment of the invention, the SET_PARAMETER request has the syntax:

SET_PARAMETER rtsp://example.com/example RTSP/1.0
Content-type: application/x-mc-notify
Content-length: command_content_len
Cseq: current_seq_num
Session: current_session_num
EOF: true

where ‘command_content_len’ represents the length of the message body in bytes, ‘current_seq_num’ is a number representing which request the RTSP SET_PARAMETER request is in the series of all requests transmitted between a media server and a network client, and ‘current_session_num’ represents the session identifier for the media streaming session between a media server and a network client.

In still another additional embodiment of the invention, the end of file message is a RTSP TEARDOWN request.

In yet still another additional embodiment of the invention, the end of the streamed media is determined in real time.

In yet another embodiment of the invention, the end of the streamed media is predetermined.

In still another embodiment of the invention, the stored media is encoded in real time.

In yet still another embodiment of the invention, the stored media is previously encoded.

Still another embodiment of the invention includes streaming media using a media server including streaming media using the media server, determining the end of the streamed media using the media server, where the end of the streamed media signals that the streamed media has been fully streamed, creating an end of file message using the media server, where the end of file message causes the recipient of the end of file message to complete decoding of any buffered media irrespective of any other buffering criteria, and sending the end of file message using the media server.

In yet another additional embodiment of the invention, the media is streamed using the Real Time Streaming Protocol (RTSP).

In still another additional embodiment of the invention, the end of file message is a RTSP SET_PARAMETER request.

In yet still another additional embodiment of the invention, the SET_PARAMETER request has the syntax:

SET_PARAMETER rtsp://example.com/example RTSP/1.0
Content-type: application/x-mc-notify
Content-length: command_content_len
Cseq: current_seq_num
Session: current_session_num
EOF: true

where ‘command_content_len’ represents the length of the message body in bytes, ‘current_seq_num’ is a number representing which request the RTSP SET_PARAMETER request is in the series of all requests transmitted between a media server and a network client, and ‘current_session_num’ represents the session identifier for the media streaming session between a media server and a network client.

In yet another embodiment of the invention, the end of file message is a RTSP TEARDOWN request.

In still another embodiment of the invention, the end of the streamed media is determined in real time.

In yet still another embodiment of the invention, the end of the streamed media is predetermined.

In yet another additional embodiment of the invention, the stored media is encoded in real time.

In still another additional embodiment of the invention, the stored media is previously encoded.

Still another embodiment of the invention includes machine readable medium containing processor instructions, where execution of the instructions by a processor causes the processor to perform a process including streaming media, determining the end of the streamed media, where the end of the streamed media signals that the streamed media has been fully streamed, creating an end of file message, where the end of file message causes the recipient of the end of file message to complete decoding of any buffered media irrespective of any other buffering criteria; and sending the end of file message.

### BRIEF DESCRIPTION OF THE DRAWINGS

FIG. 1 is a system diagram of a system for streaming video data in accordance with an embodiment of the invention.

FIG. 2 conceptually illustrates a network client configured to perform dynamic video scaling in accordance with an embodiment of the invention.

FIG. 3 is a flow chart illustrating a process for streaming video data using RTSP in accordance with an embodiment of the invention.

FIG. 4 is a flow chart illustrating a process for decoding streamed video data using RTSP in accordance with an embodiment of the invention.

### DETAILED DESCRIPTION

Turning now to the drawings, systems and methods for media streaming using the Real Time Streaming Protocol (RTSP) with reduced delays in accordance with embodiments of the invention are disclosed. When streaming media using RTSP, a state is created and used to identify the streaming session. A variety of control messages are used to control the streaming session including control messages that can be used to terminate the session, stopping all media streaming and releasing any session data stored on the media server. Due to the streaming nature of RTSP, there is typically no way for a media sever to notify a network client that the media stream has been fully streamed on the server side.

In order to provide a smooth playback experience, network clients in accordance with embodiments of the invention buffer incoming streamed media in order to accommodate fluctuations in network latency and/or other performance issues. Once a sufficient amount of streamed media has been buffered, the network client will decode the buffered media. In accordance with embodiments of the invention, a sufficient amount of buffered media is enough to prevent a buffer underflow, ensuring a steady stream of buffered media being delivered to the media decoder, but not so much where the network client experiences buffer overflow, impacting the ability of the network client to receive streamed media. In many embodiments, a sufficient amount of buffered media is defined using a buffering criteria. In many embodiments, the buffering criteria is that a predetermined amount of media is buffered, that media having a predetermined playback duration is buffered, and/or any other criteria typically used to control the amount of media buffered by a network client. In several embodiments, the buffering criteria is to simply wait for a period of time referred to as the client playout delay before playing back the content. Although buffering can help provide a smooth playback experience, network and/or other performance issues can result in delays in buffering a sufficient amount of streamed media in order to begin decoding the buffered media. In accordance with embodiments of the invention, network clients may implement a timeout threshold, where the network client will decode buffered media even if an insufficient amount of media to support smooth playback of the media has been buffered.

In cases of a high latency network connection between the media server and a network client, delays in the playback of the media streamed using RTSP may be extremely long. In many embodiments of the invention, timeout thresholds for network clients may be a minute or longer in order to compensate for a high latency network connection. In the worst case, a network client may have an infinite timeout threshold and the playback of the streamed media may never complete. Further compounding the potential for delays, a poor network connection may prevent a control message terminating the session from being sent, causing the client machine to reach its timeout threshold before completing playback of the media stream. Streaming systems in accordance with many embodiments of the invention can avoid problems associated with delays in the playback of media streams by having media servers notify network clients when the end of the media stream is reached. By notifying network clients that the end of the media stream has been reached, network clients can complete playback of the streamed media without waiting for a control message that terminates the session, or a timeout threshold. In many embodiments, the notification is provided by sending an end of file message. In several embodiments, the end of file message is contained within an RTSP SET_PARAMETER request. Systems and methods for media streaming using RTSP with reduced delays in accordance with embodiments of the invention are discussed further below.

### System Overview

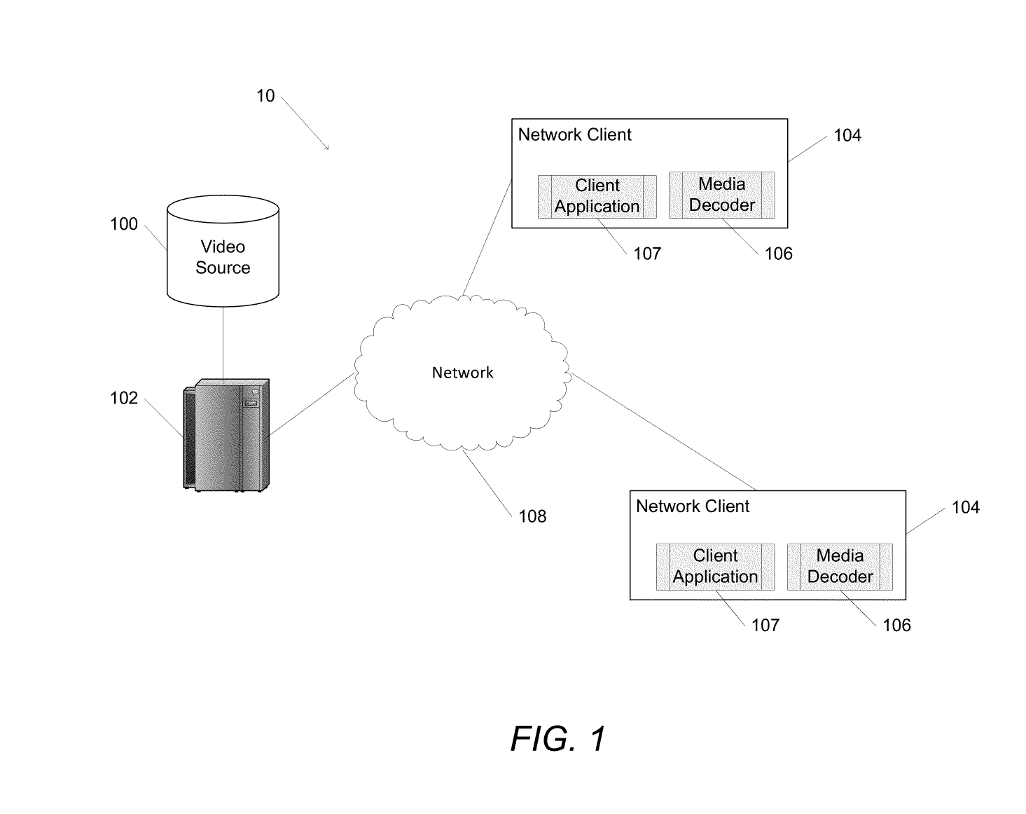

Media streaming networks in accordance with embodiments of the invention are configured to notify network clients when the network server has reached the end of the media that is being streamed. A media streaming network in accordance with an embodiment of the invention is illustrated in FIG. 1. The illustrated media streaming network 10 includes a media source 100. In a number of embodiments of the invention, the media source 100 contains pre-encoded media. In several embodiments of the invention, the media source encodes media in real time. The media source 100 is connected to a network renderer 102. In many embodiments, the media source 100 and the network renderer 102 are implemented using a media server. The network renderer 102 is connected to a plurality of network clients 104 utilizing a network 108. As discussed further below, the network renderer 102 is configured to stream media to the network clients 104 utilizing RTSP.

In many embodiments of the invention, the network renderer 102 is implemented using a single machine. In several embodiments of the invention, the network renderer is implemented using a plurality of machines. In many embodiments of the invention, the network renderer and the media source are implemented using a media server. In many embodiments, the network 108 is the Internet. In several embodiments, the network 108 is any IP network.

The network clients 104 contain a media decoder 106 and a client application 107. In several embodiments of the invention, the network client 104 is configured to receive and buffer media streamed utilizing RTSP using the client application 107. In a number of embodiments, the client application 107 is configured to deliver buffered media to the media decoder 106 for decoding and playback. In many embodiments, buffered media is delivered to the media decoder 106 by the client application 107 once the client application 107 has buffered a sufficient amount of media. In a number of embodiments, a sufficient amount of media is determined based on network and/or network client performance. In several embodiments, a sufficient amount of media is pre-determined. In many embodiments, the network client 104 is configured to decode media received after a timeout delay, even if a sufficient amount of media has not been buffered. In a number of embodiments, the network client 106 is configured to receive and process a RTSP SET_PARAMETER request. In several embodiments, the network client is configured to receive and process any RTSP request.

A variety of RTSP requests are used to set up, control, and end the streaming of media between a media server and a network client. A DESCRIBE request returns a presentation description, usually in the Session Description Protocol format, describing the media streams available and information related to the media streams for a given RTSP URL. A SETUP request, sent from a network client to a media server, is used to define the protocols and ports which will be used by the network client and media server in order to stream the data. Once the SETUP request has been made, a PLAY request is used to begin streaming media. A PLAY request is sent for every stream which is to be played back. A TEARDOWN request may be used to terminate the session, stopping all media streaming and releasing any session data stored on the media server. Media is streamed and played back by a network client until a TEARDOWN request is received or the network client reaches a timeout threshold regarding the network connection to the media server. Although specific requests have been described above, other RTSP requests may be utilized in accordance with embodiments of the invention. The definition and implementation of each type of RTSP request is described in Internet Engineering Task Force RFC 2326, the entirety of which is incorporated by reference.

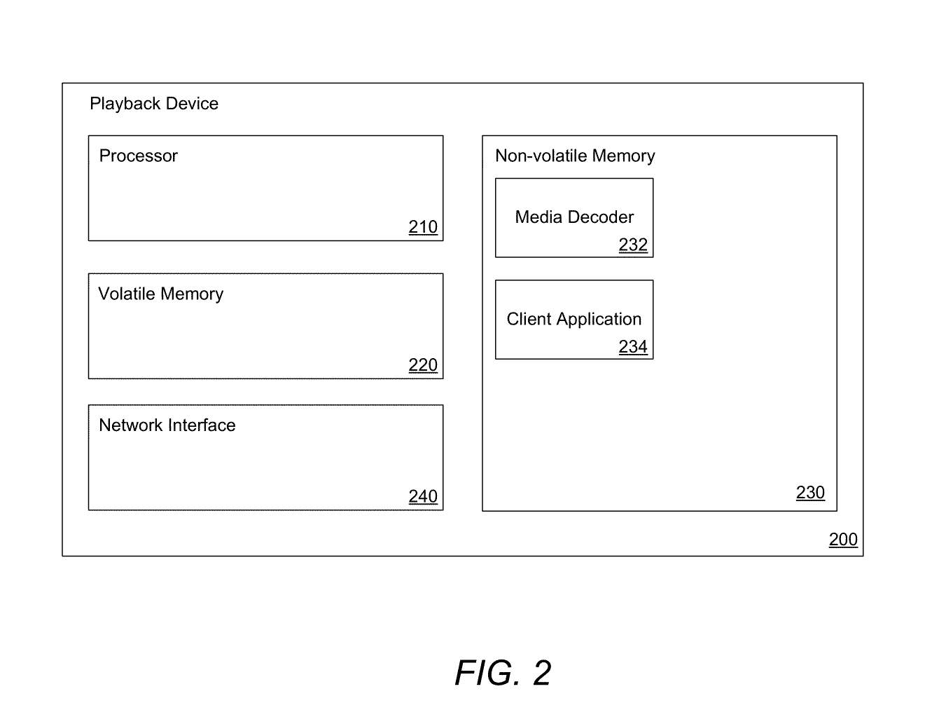

In many embodiments of the invention, network clients can include consumer electronics devices such as DVD players, Blu-ray players, televisions, set top boxes, video game consoles, tablets, and other devices that are capable of received media streamed utilizing RTSP and playing back the streamed media. The basic architecture of a network client in accordance with an embodiment of the invention is illustrated in FIG. 2. The network client 200 includes a processor 210 in communication with non-volatile memory 230, volatile memory 220, and a network interface 240. In the illustrated embodiment, the non-volatile memory includes a media decoder 232 that configures the processor to decode media and a client application 234 configured to buffer streamed media and deliver the streamed media to the media decoder 232. In several embodiments, the network interface 240 may be in communication with the processor 210, the volatile memory 220, and/or the non-volatile memory 230. Although a specific network client architecture is illustrated in FIG. 2, any of a variety of architectures including architectures where the media decoder is located on disk or some other form of storage and is loaded into volatile memory at runtime can be utilized to implement network clients in accordance with embodiments of the invention.

Although a specific architecture of a media streaming network is shown in FIG. 1, other implementations appropriate to a specific application can be utilized in accordance with embodiments of the invention. Methods for streaming media using RTSP with reduced delays in accordance with embodiments of the invention are discussed below.

Media Streaming using RTSP with Reduced Delays

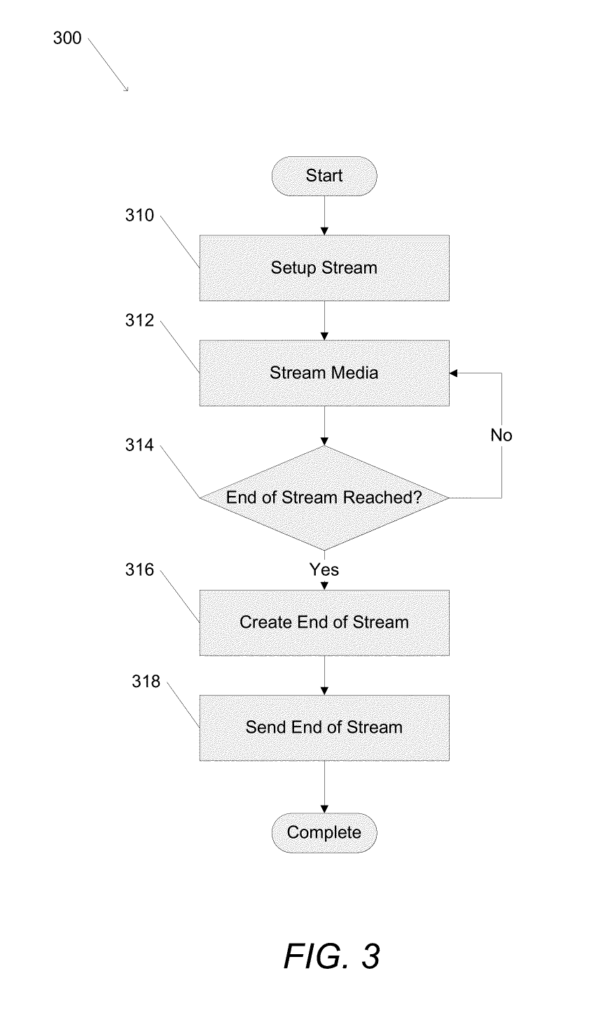

Streaming media using RTSP is subject to delays in the delivery, decoding and display of the streamed media when network conditions are poor. This problem is particularly prevalent when decoding and displaying the end of a media stream, as a delay in receiving the end of the media stream can result in a delay in the buffered media being delivered to the decoder. This delay in turn can result in further delays in the decoding of the end of the media stream. A process for reducing the delay in the decoding and display of streamed media in accordance with an embodiment of the invention is illustrated in FIG. 3. The process 300 includes setting (310) up a stream for streaming media. In many embodiments, the media stream set up (310) is between a network renderer and a network client. The media is streamed (312). If the end of the stream has not been reached (314), the media continues streaming (312). Once the end of the stream is reached (314), an end of file message is created (316). In several embodiments, the message created (316) is a RTSP SET_PARAMETER request. The end of file message is sent (318). In a number of embodiments, the end of file message is sent (318) from a network renderer to a network client.

In accordance with embodiments of the invention, it is useful to utilize the RTSP SET_PARAMETER request to create the end of file message. In many embodiments, the RTSP SET_PARAMETER request enables compatibility with older network clients supporting media streaming using RTSP. In many embodiments of the invention, the RTSP SET_PARAMETER request may use the syntax:

SET_PARAMETER rtsp://example.com/example RTSP/1.0
Content-type: application/x-mc-notify
Content-length: command_content_len
Cseq: current_seq_num
Session: current_session_num
EOF: true

In a number of embodiments, the placeholder values ‘command_content_len’, ‘current_seq_num’, and ‘current_session_num’ shown in above represent the following:

‘command_content_len’ represents the length of the message body in bytes,

‘current_seq_num’ is a number representing which request the RTSP SET_PARAMETER request is in the series of all requests transmitted between a media server and a network client, and

‘current_session_num’ represents the session identifier for the media streaming session between a media server and a network client.

The values of the above fields depend on the specific RTSP media streaming session.

A specific process for media streaming using RTSP with reduced delays is described above; however, a variety of processes for media streaming using RTSP with reduced delays may be utilized in accordance with embodiments of the invention. For example, processes can be utilized that provide end of file messages utilizing a mechanism other than the RTSP SET_PARAMETER request and/or that use alternative syntaxes to the syntax described above. Processes for network client behavior when dealing with end of file message in accordance with embodiments of the invention are discussed below.

### End of File Message Handling

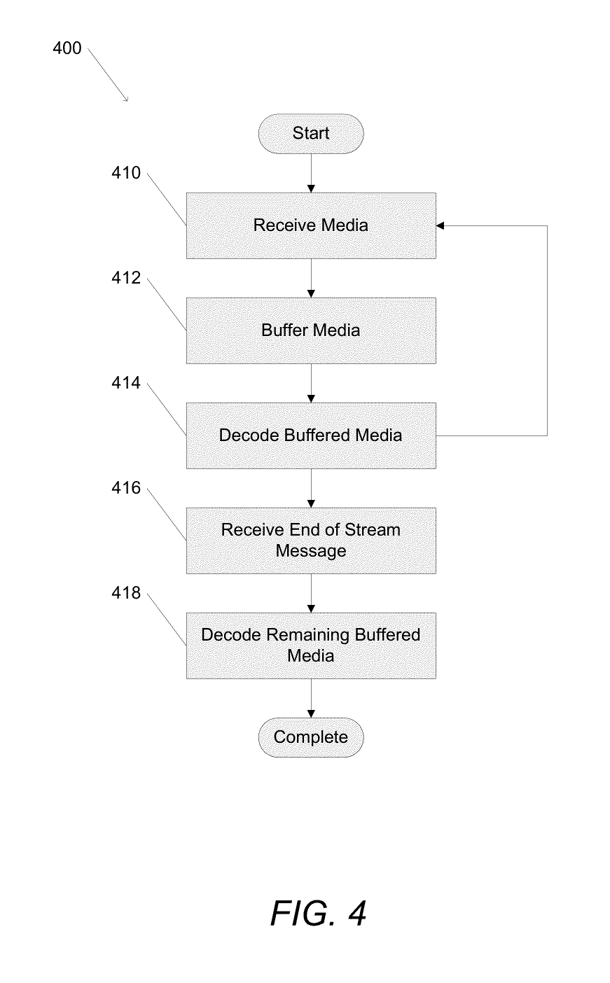

Upon receiving an end of file message, network clients receiving streamed media can immediately decode any received streamed media. A process for handling end of file messages using a network client in accordance with an embodiment of the invention is illustrated in FIG. 4. The process 400 includes receiving (410) media. In a number of embodiments, the received (410) media is streamed from a media server. In several embodiments, the received media is buffered (412). Once a sufficient amount of media has been buffered (412) as determined using at least one buffering criteria, the buffered media is decoded (414). In many embodiments, the buffered media is decoded (414) using a media decoder.

A network client will continue to receive (410), buffer (412), and decode (414) the media stream until an end of file message is received (416). Upon receiving (416) the end of file message, the remaining buffered media is decoded (418). In several embodiments, the end of file message is an RTSP SET_PARAMETER request. In a number of embodiments, the end of file message is an RTSP TEARDOWN request initiated by the server instead of by the network client. In many embodiments, the buffered media would not have been decoded (418) if the end of file message had not been received (416).

A specific process for handling an end of file message is described above; however, a variety of processes may be utilized for handling end of file messages in accordance with embodiments of the invention. Although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive. Accordingly, the scope of the invention should be determined not by the embodiments illustrated, but by the appended claims and their equivalents.

What is claimed:

1. A media server, comprising:
media storage containing stored media;
wherein the media server is configured to:
stream media stored in the media storage;
determine the end of the streamed media, where the end of the streamed media signals that the streamed media has been fully streamed;
create an end of file message, where the end of file message causes the recipient of the end of file message to complete decoding of any buffered media irrespective of any other buffering criteria; and
send the end of file message.

2. The media server of claim 1, where the media is streamed using the Real Time Streaming Protocol (RTSP).

3. The media server of claim 2, where the end of file message is a RTSP SET_PARAMETER request.

4. The media server of claim 3, where the SET_PARAMETER request has the syntax:
SET_PARAMETER rtsp://example.com/example RTSP/1.0
Content-type: application/x-mc-notify
Content-length: command_content_len
Cseq: current_seq_num
Session: current_session_num
EOF: true
where ‘command_content_len’ represents the length of the message body in bytes, ‘current_seq_num’ is a number representing which request the RTSP SET_PARAMETER request is in the series of all requests transmitted between a media server and a network client, and ‘current_session_num’ represents the session identifier for the media streaming session between a media server and a network client.

5. The media server of claim 2, where the end of file message is a RTSP TEARDOWN request.

6. The media server of claim 2, where the end of the streamed media is determined in real time.

7. The media server of claim 2, where the end of the streamed media is predetermined.

8. The media server of claim 2, where the stored media is encoded in real time.

9. The media server of claim 2, where the stored media is previously encoded.

10. A method for streaming media using a media server, comprising:
streaming media using the media server;
determining the end of the streamed media using the media server, where the end of the streamed media signals that the streamed media has been fully streamed;
creating an end of file message using the media server, where the end of file message causes the recipient of the end of file message to complete decoding of any buffered media irrespective of any other buffering criteria; and
sending the end of file message using the media server.

11. The method of claim 10, where the media is streamed using the Real Time Streaming Protocol (RTSP).

12. The method of claim 11, where the end of file message is a RTSP SET_PARAMETER request.

13. The method of claim 12, where the SET_PARAMETER request has the syntax:
SET_PARAMETER rtsp://example.com/example RTSP/1.0
Content-type: application/x-mc-notify
Content-length: command_content_len
Cseq: current_seq_num
Session: current_session_num
EOF: true
where ‘command_content_len’ represents the length of the message body in bytes, ‘current_seq_num’ is a number representing which request the RTSP SET_PARAMETER request is in the series of all requests transmitted between a media server and a network client, and ‘current_session_num’ represents the session identifier for the media streaming session between a media server and a network client.

14. The method of claim 11, where the end of file message is a RTSP TEARDOWN request.

15. The method of claim 11, where the end of the streamed media is determined in real time.

16. The method of claim 11, where the end of the streamed media is predetermined.

17. The method of claim 11, where the stored media is encoded in real time.

18. The method of claim 11, where the stored media is previously encoded.

19. A machine readable medium containing processor instructions, where execution of the instructions by a processor causes the processor to perform a process comprising:
streaming media;
determining the end of the streamed media, where the end of the streamed media signals that the streamed media has been fully streamed;
creating an end of file message, where the end of file message causes the recipient of the end of file message to complete decoding of any buffered media irrespective of any other buffering criteria; and
sending the end of file message.
